(19) United States
(12) Patent Application Publication
(10) Pub. No.: US 2007/0201938 A1
(43) Pub. Date: Aug. 30, 2007

(54) LOCKING MECHANISM FOR COVER

(75) Inventor: Takashi Hosono, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/679,652

(22) Filed: Feb. 27, 2007

(30) Foreign Application Priority Data
Feb. 28, 2006 (JP) 2006-052903

(51) Int. Cl. B41J 29/02

(52) U.S. Cl. 400/691

(57) ABSTRACT

A locking mechanism for a cover is provided which locks the cover in a closed state. The locking mechanism includes a slider that is elastically urged in a direction perpendicular to the opening and closing direction of the cover so as to suppress movement of the slider in one direction when the cover is opened. When the cover is closed, the slider is pressed down by the protrusion to release the slider so as to allow the slider to slide, and the engaging portions engage the locking portions of first and second protrusions, respectively, so as to lock the cover.

This application claims the benefit of priority under 35 U.S.C. §119 to Japanese Patent Application No. 2006-052903, filed Feb. 28, 2006, which is hereby incorporated by reference in its entirety.

### BACKGROUND OF THE INVENTION

1. Field of the Invention

The present invention relates to a locking mechanism for a cover, and more particularly, to a locking mechanism for a cover capable of opening and closing an opening formed in a case of a printer or the like.

2. Description of the Related Art

A known locking mechanism of a cover will be described with reference to JP-A-11-025941. As shown in FIG. 7, a battery cover 33 for closing a battery receiving portion 32 is formed in a case 31 of a digital camera or the like, and a lock lever 34 having a lock claw 34a at the end thereof is slidably attached to the battery cover 33.

The lock claw 34a engages with an engaging portion 35 protruding from the case 31. The lock claw 34a is formed in a hook shape from an inner surface 34b and a slope 34c, and an unlocking knob 34d is formed so as to protrude upward from the battery cover 33.

An engaging surface 35a is formed on the bottom surface of the engaging portion 35 and an angular portion 35b is formed at the end thereof. The angular portion 35b abuts on the slope 34b of the lock claw 34a and slides downwardly.

The lock lever 34 is elastically urged to the left side in the figure by a coil spring 36. The inner surface 34b of the lock claw 34a is sloped so that the left end in the figure is raised at an angle of 15°±10° relative to the engaging surface 35a of the engaging portion 35

When operating the known locking mechanism for the cover, as indicated by the dashed line, when the battery cover 33 is moved from the opened state to the closed state, the slope 34b of the lock claw 34a of the lock lever 34 abuts the angular portion 35b of the engaging portion 35. When the lock lever 34 is further pushed in, the lock lever 34 moves to right against the urging force of the coil spring 36. Accordingly, the end of the lock claw 34a contacts the end of the engaging portion 35, and the inner surface 34b of the lock claw 34a engages the engaging surface 35a of the engaging portion 35, thereby locking the battery cover 33.

When unlocking the battery cover 33 by allowing the unlocking knob 34b to slide to right against the urging force of the coil spring 36, the lock claw 34a departs from the engaging portion 35 to release the battery cover 33, for example, so that a battery can be replaced.

JP-A-11-025941 and JP-A-10-199223 disclose examples of the known locking mechanism.

However, in the known locking mechanism for a cover described above, when the battery cover 33 is pressed down and closed, the end portion of the lock claw 34a is lowered while abutting the end portion of the engaging portion 35, thereby increasing the downward pressure required, due to the friction of sliding the lock lever 34.

Accordingly, an operator can incorrectly close the battery cover 33 if the lock lever is not pressed all the way down, thus leaving the battery cover in a half locked state.

When the battery cover 33 is in the half locked state and external vibration is applied thereto, the battery cover 33 may be opened and thus a battery (not shown) may become dislodged.

### SUMMARY OF THE INVENTION

The present invention solves the above-mentioned problem. An advantage of the invention is to provide a locking mechanism for a cover which can satisfactorily lock the cover in a closed state.

According to a first aspect of the invention, there is provided a locking mechanism including: a case of which one side is opened; and a cover capable of opening and closing the case, wherein a locking portion is formed in a protrusion protruding by a predetermined size from the cover into the case, a slider disposed in the case capable of sliding in a direction perpendicular to the opening and closing direction of the cover, and an engaging portion formed in the slider capable of engaging with the locking portion to lock the cover when the cover is closed, wherein the slider is biased in one of the directions perpendicular to the opening and closing direction of the cover so as to suppress movement of the slider in the direction when the cover is opened. When the cover is closed, the slider is pressed down by the protrusion, the slider is released so as to allow the slider to slide in the one direction, and the engaging portion engages with the locking portion so as to lock the cover.

In a second aspect of the invention, an abutment portion which is pressed by an end of the protrusion formed in the cover may be formed in the slider. Here, when the cover is closed, the protrusion may press the abutment portion to press down the slider.

In a third aspect of the invention, a pair of first and second protrusions may be formed in the cover with a predetermined gap therebetween, and a pair of first and second engaging portions may be formed at positions of the slider corresponding to the first and second protrusions.

In a fourth aspect of the invention, the slider may be slidably supported by an attachment plate attached to the inside of the case, and a position control portion for controlling movement of the slider in the one direction may be formed in the attachment plate. When the cover is closed, the first protrusion may press the abutment portion, and to release the control of the position control portion, the slider may slide in the one direction.

In a fifth aspect of the invention, a supporting portion slidably supporting the slider may be formed in the attachment plate and a pair of first and second supporting portions may be formed with a predetermined gap therebetween in a direction in which the slider slides.

In a sixth aspect of the invention, the first supporting portion may be formed in the vicinity of the abutment portion and the abutment portion may be formed at a position capable of being pressed by the first protrusion on the slider side. Here, when the cover is closed, the first protrusion may press the abutment portion, the slider may rotate about the second supporting portion formed with a predetermined gap between the first supporting portion and the second supporting portion, and the abutment portion may be pressed down to release the control of the position control portion.

In a seventh aspect of the invention, when the control of the position control portion is released, the slider may slide in the one direction to go below the position control portion and to control the upward movement of the slider.

In an eighth aspect of the invention, the lock of the engaging portion to the locking portion may be released and the abutment portion of the slider may rotate upward about the second supporting portion, by pressing the slider in the opposite direction so as to slide in a state where the cover is locked to the case.

In a ninth aspect of the invention, the locking portion may be formed in a “⊃” shape and the engaging portion may be formed in a shape capable of engaging with the locking portion by allowing a part of the slider to protrude.

In a tenth aspect of the invention, the cover may be always elastically urged in a direction in which the cover is opened.

In an eleventh aspect of the invention, the end of the first protrusion and the abutment portion may have an inclined shape of which the right side is raised in a front view.

According to the invention, the slider is always elastically urged in one direction perpendicular to the opening and closing direction of the cover so as to suppress movement of the slider in the direction when the cover is opened. When the cover is closed, the slider is pressed down by the protrusion, the slider is released so as to allow the slider to slide in the one direction, and the engaging portion engages with the locking portion so as to lock the cover. Accordingly, the engaging portion of the slider elastically urged in one direction engages with the locking portion. Therefore, the problem of the half locked state described above with respect to known art can be prevented from occurring in the present invention.

The abutment portion which is abutted and pressed by an end of the protrusion formed in the cover is formed in the slider. Here, when the cover is closed, the protrusion may press the abutment portion to press down the slider. Accordingly, it is possible to release the control of the movement of the slider in the one direction. Since a pair of first and second protrusions is formed in the cover with a predetermined gap therebetween, and a pair of first and second engaging portions is formed at positions of the slider corresponding to the first and second protrusions, the cover can be locked with two locking portions, thereby securely locking the cover.

The slider is slidably supported by an attachment plate attached to the inside of the case, and a position control portion for controlling movement of the slider in the one direction is formed in the attachment plate. When the cover is closed, the first protrusion presses the abutment portion, and to release the control of the position control portion the slider slides in the one direction. Accordingly, it is possible to satisfactorily lock the cover.

Since the supporting portion slidably supporting the slider is formed in the attachment plate and a pair of first and second supporting portions is formed with a predetermined gap therebetween in a direction in which the slider slides, it is possible to satisfactorily support the slider with two supporting portions.

The first supporting portion is formed in the vicinity of the abutment portion, and the abutment portion is formed at a position capable of being pressed by the first protrusion on the slider side. When the cover is closed, the first protrusion may press the abutment portion, and the slider rotates about the second supporting portion formed with a predetermined gap between the first supporting portion and the second supporting portion, and the abutment portion is pressed down to release the control of the position control portion. Accordingly, the slider slides in the one direction (to the right side in the figures), thereby locking the engaging portion to the locking portion.

When the control of the position control portion is released, the slider slides in the one direction to go below the position control portion and to control the upward movement of the slider. Accordingly, when the locking portion engages with the engaging portion, the upward movement of the slider is controlled. Therefore, it is possible to obtain a securely locked state without cover vibration or clattering.

The lock between the engaging portion and the locking portion is released and the abutment portion of the slider rotates upward about the second supporting portion, by pressing the slider in the opposite direction. Accordingly, the unlocking operation is positively performed.

Since the locking portion is formed in a “⊃” shape and the engaging portion is formed in a shape capable of engaging with the locking portion by allowing a part of the slider to protrude, it is possible to securely lock the engaging portion to the locking portion.

Since the cover is always elastically urged in a direction in which the cover is open, the cover may be opened by a predetermined amount after the unlocking operation is performed.

The end portion of the first protrusion and the abutment portion have an inclined shape of which the right side is raised in a front view. Accordingly, from which position the cover is pressed down, it is possible to press down the abutment portion on the slope of the first protrusion.

### BRIEF DESCRIPTION OF THE DRAWINGS

FIG. 1 is a partial sectional view of a case and a cover illustrating a locking mechanism according to an embodiment of the present invention.

FIG. 2 is a side view of FIG. 1.

FIG. 3 is a partial sectional view illustrating an unlocked state.

FIG. 4 is a side view of FIG. 3.

FIG. 5 is a partial sectional view illustrating an operation of a locking mechanism according to an embodiment of the invention.

FIG. 6 is a side view illustrating a state where the cover is completely opened.

FIG. 7 is a schematic diagram illustrating a known locking mechanism.

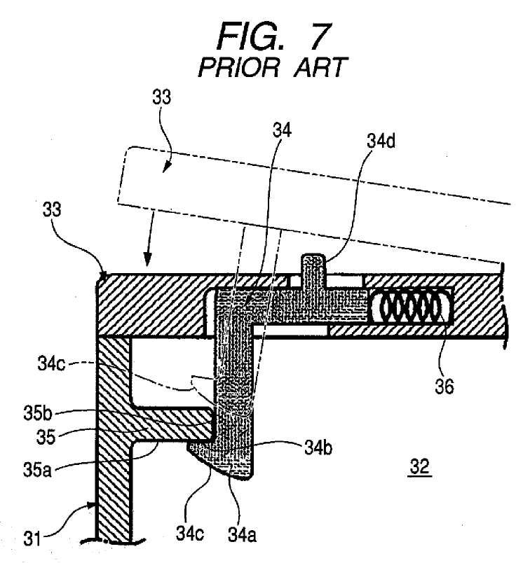

### DESCRIPTION OF THE PREFERRED EMBODIMENTS

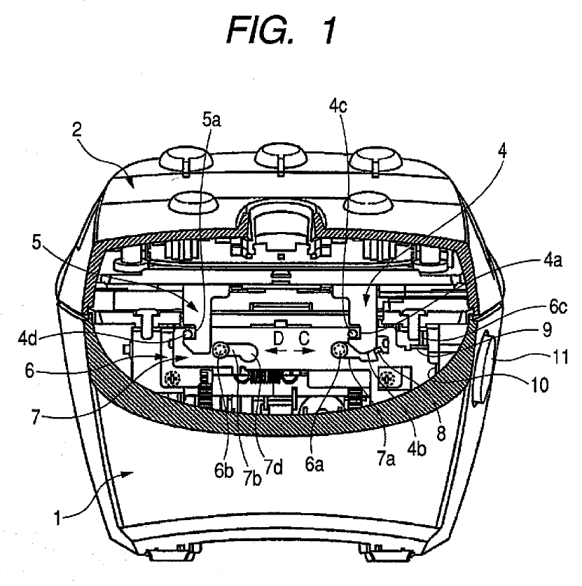

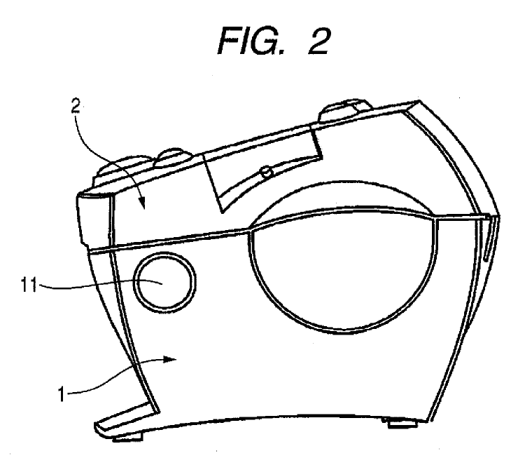

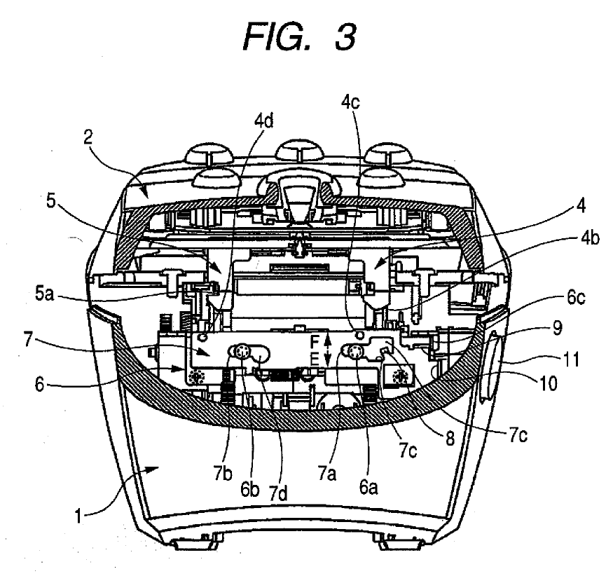

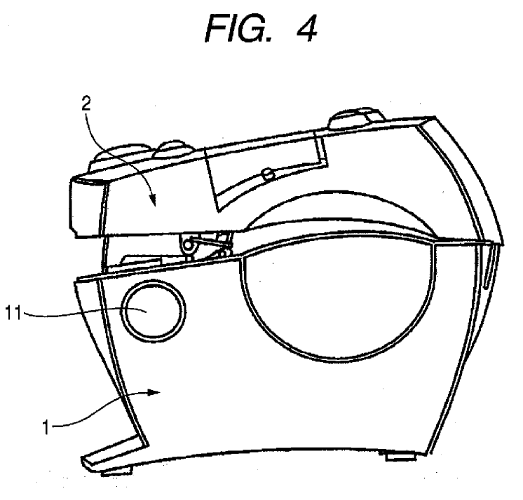

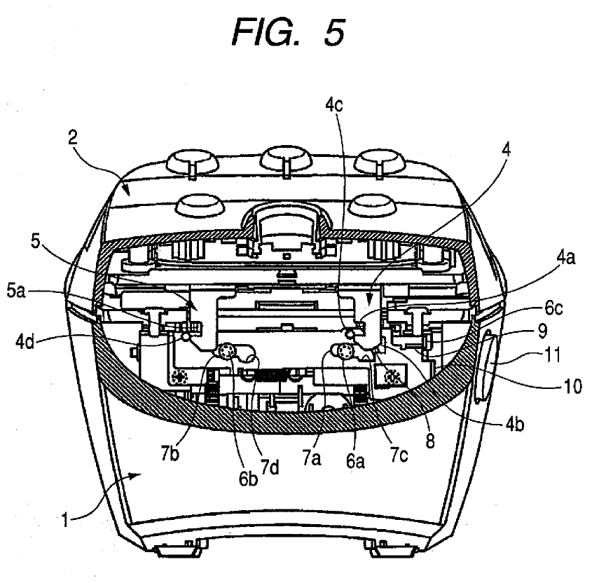

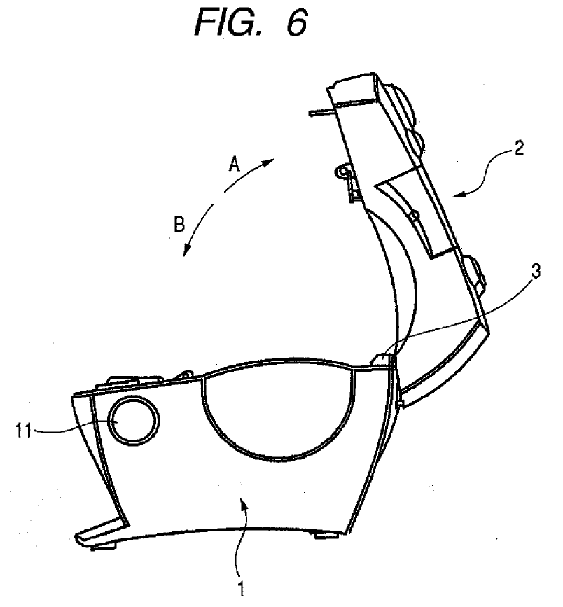

A locking mechanism for a cover according to an embodiment of the invention will be described with reference to the drawings. FIG. 1 is a partial sectional view of a case and a cover illustrating a locking mechanism according to an embodiment of the present invention. FIG. 2 is a side view of FIG. 1, FIG. 3 is a partial sectional view illustrating a locked state, FIG. 4 is a side view of FIG. 3, FIG. 5 is a partial sectional view illustrating a locking operation according to an embodiment of the invention, and FIG. 6 is a side view illustrating a state where the cover is completely opened.

First, it is assumed that the locking mechanism is applied to a printer for printing an image on a paper roll. As shown in FIGS. 1 to 6, a case 1 includes therein a printing unit (not shown) having printing means such as a print head and a paper receiving unit (not shown) receiving the roll of paper or the like.

One side of the case 1, that is, the upper side in the figure, is opened to receive the roll of paper in the paper receiving portion. A cover 2 capable of opening and closing the opened side of the case 1 is provided, and the cover 2 is elastically urged in the direction of arrow A about a hinge portion 3 on the right side as shown in FIG. 6.

FIGS. 1, 3, and 5 show partial sectional views which are obtained by cutting the front sides of the case 1 and the cover 2 from the hatched portion, so as to illustrate the locking mechanism according to an embodiment of the invention.

As shown in FIG. 1, a pair of protrusions 4 on the right side and a protrusion 5 on the left side, which both protrude downward with a predetermined height, is formed in the cover 2 with a predetermined gap therebetween. Locking portions 4a and 5a having a “⊃” shape are formed on the left side with a predetermined size in the protrusions 4 and 5. A slope 4b of which the right side in a front view is raised, is formed at the lower end of the first protrusion 4, and the slope 4b can press an abutment portion 8 of the slider 7, as will be described herein.

By forming the slope 4b, the right side of which is raised, at the end portion of the first protrusion 4, it is possible to positively press the abutment portion 8 with the slope 4b, even when the left side of the cover 1 away from the first protrusion 4 is pressed in the direction of arrow B.

As shown in FIGS. 1, 3, and 5, an attachment plate 6 rising upright is disposed inside the case 1 and rod-shaped first and second supporting portions 6a and 6b protrude forwardly in the horizontal direction from the attachment plate 6.

A position control portion 6c, the right side of which is raised upright, is formed in the attachment portion 6, and an elastic contact portion 9 of the slider 7 comes in elastic contact with the position control portion 6c.

The rod-shaped first and second supporting portion 6a and 6b have a small diameter at the base end and a large diameter at the end portion, thereby forming a step-like shape. The slider 7 is supported by the first and second supporting portions 6a and 6b so as to be slidable in the directions of arrows C and D in a direction perpendicular to the opening and closing directions of the cover 2, as indicated by arrows A and B.

A first groove 7a, which is longitudinal in the horizontal directions of arrow C and D and which is fitted to the first supporting portion 6a and a second groove 7b, which is longitudinal in the horizontal directions and which is fitted to the second supporting portion 6b, are formed in the slider 7.

The width of the first groove 7a is larger than the diameter at the base end of the first supporting portion 6a, both of which are backlash-fitted to each other, and is smaller than the diameter at the end portion of the first supporting portion 6a. The width of the second groove 7b is almost equal to the diameter of the base end of the second supporting portion 6b so as to be slidable.

Accordingly the slider 7 supported by the first and second supporting portions 6a and 6b can slide in the horizontal directions of arrow C and D, and the first groove 7a side can rotate in the vertical directions indicated by arrows E and F about the second supporting portion 6b.

The amount of rotation of the slider 7 in the directions of arrows E and F is equal to the backlash size of the first groove 7a with respect to the first supporting portion 6a.

As shown in FIG. 3, a large-width portion 7c into which the large-diameter end portion of the first supporting portion 6a can be inserted is formed on the right side of the first groove 7a, and an abutment portion 8 is provided which is obtained by cutting and raising the lower portion of the large-width portion 7c so that the right side in a plan view in the same direction as the slope 4b of the first protrusion 4, is raised upward.

A large-width portion 7e into which the large-diameter end portion of the second supporting portion 6b is formed on the right side of the second groove 7b.

Accordingly, by inserting the large-width portions 7c and 7d of the slider 7 into the first and second supporting portions 6a and 6b and then allowing the large-width portions 7c and 7d to slide to right, as shown in the figure, the slider 7 is supported by the first and second supporting portions 6a and 6b, and is attached to the attachment plate 6 so as to be slidable in the directions of arrows C and D and to be rotatable in the directions of arrows E and F.

In the slider 7, as shown in FIG. 1, a pair of first and second engaging portions 4c and 4d, which can engage with the locking portions 4a and 5a of the first and second protrusions 4 and 5 to lock the cover 2 when the cover 2 is closed, protrude forwardly with a predetermined height.

In the slider 7, the elastic contact portion 9, which can elasticly contact the position control portion 6c of the attachment plate 6, is cut and raised, and a bearing portion 10 which can be pressed by an operating knob 11 is formed at the right end thereof, as shown in the figure.

The slider attached to the attachment plate 6 is elastically urged in the direction of arrow C (the right-hand direction in the figure) with an elastic member (not shown), such as a coil spring, and the abutment portion 8 is elastically urged in the upward direction of arrow F.

In the case 1, the operating knob 11 which can externally press the slider 7 in the direction of arrow D, is disposed on the right side in the figure so as to be exposed externally. By pressing the operating knob 11 in the multi-directions of arrow D, the bearing portion 10 is pressed by the operating knob 11 and the slider 7 slides in the direction of arrow D in the state where the elastic contact portion 9 disengages from the position control portion 6c of the attachment plate 6. Then, the elastic contact portion 9 elasticly contacts the side surface of the position control portion 6c so as to control the movement of the slider 7 in the direction of arrow C.

Operations of the locking mechanism for a cover according to an embodiment of the invention will be described now. First, in the state where the cover 2 is opened (see FIGS. 4 and 6), the first and second protrusions 4 and 5 are separated from the slider 7, which is an initial state.

In the initial state, the slider 7 is pressed toward the left, as indicated by arrow D, against the urging force of the elastic member, and the abutment portion 8 rotates in the upward direction of arrow F about the second supporting portion 6b.

Accordingly, the movement of the slider 7 in the direction of arrow C is controlled by bringing the elastic contact portion 9 into elastic contact with the side surface of the position control portion 6c of the attachment plate 6.

When the locking mechanism is in the initial state and the cover 2 is pressed in the direction of arrow B, as shown in FIG. 5, the slope 4b of the first protrusion 4 abuts the abutment portion 8. Accordingly, the abutment portion 8 side of the slider 7 rotates in the downward direction of arrow E about the second supporting portion 6b.

Then, the elastic contact portion 9 disengages from the position control portion 6c and the slider slides in the direction of arrow C with the urging force of the urging member. At the same time, the locking portions 4a and 5a engage with the first and second engaging portions 4c and 4d.

The movement in the upward direction of arrow F of the slider 7 sliding in the direction of arrow C is controlled by bringing the elastic contact portion 9 into elastic contact with the lower portion of the position control portion 6c of the attachment plate 6.

That is, when the locking mechanism is in the locked state, the upward movement of the slider 7 is controlled by the second supporting portion 6b and the position control portion 6c.

By allowing the first and second engaging portions 4c and 4d to engage with the locking portions 4a and 5a, the cover 2 is securely locked to the case 1. Accordingly, even when external vibration or force is applied, the case will not unlock.

Next, when the cover 2 is to be opened, the externally exposed operating knob 11 is pressed in the direction of arrow D. The bearing portion 10 is then pressed by the operating knob 11 and the slider 7 slides in the direction of arrow D, whereby the elastic contact portion 9 disengages from the lower side of the position control portion 6c.

Accordingly, the abutment portion 8 side rotates upwardly about the second supporting portion 6b, the elastic contact portion 9 comes in elastic contact with the side surface of the position control portion 6c, and the movement in the direction of arrow C of the slider 7 is controlled, whereby the locking mechanism returns to the initial state.

Although it has been described that the locking portions 4a and 5a have a “⊃” shape, the shape of the locking portions is not limited to the “⊃” shape, but may be any suitable shape if it can lock the engaging portions 4c and 4d. Although it has been described that the operating knob 11 is disposed on the right side in the figure and the slider 7 is allowed to slide in the same direction as the pressing direction of the operating knob 11, the slider 7 may be allowed to slide in the horizontal direction by disposing the operating knob 11 on the front side of the case 1 and by pushing the operating knob 11 in the direction perpendicular to the paper plane.

What is claimed is:

1. A locking mechanism comprising:
a case having an opening;
a cover capable of opening and closing the opening;
a locking portion is formed in a protrusion protruding by a predetermined amount from the cover into the case;
a slider adapted to slide in directions perpendicular to the opening and closing directions of the cover;
an engaging portion formed in the slider configured to engage the locking portion to lock the cover when the cover is closed,
wherein the slider is elastically urged in a direction perpendicular to the opening and closing directions of the cover so as to suppress movement of the slider in the one direction when the cover is opened, and
wherein when the cover is closed, the slider is pressed down by the protrusion, the suppression of movement of the slider in the one direction is released so as to allow the slider to slide in the one direction, and the engaging portion engages with the locking portion so as to lock the cover.

2. The locking mechanism according to claim 1, wherein an abutment portion is formed in the slider, the abutment portion is pressed by an end of the protrusion formed in the cover, wherein when the cover is closed, the protrusion presses the abutment portion to press down the slider.

3. The locking mechanism according to claim 1, further including
a pair of first and second protrusions are formed in the cover with a predetermined gap therebetween; and
a pair of first and second engaging portions are formed at positions of the slider corresponding to the first and second protrusions.

4. The locking mechanism according to claim 2, wherein the slider is slidably supported by an attachment plate attached to an inside portion of the case, and a position control portion for controlling movement of the slider in the one direction is formed in the attachment plate, and
wherein when the cover is closed, the first protrusion presses the abutment portion to release the position control portion so that the slider slides in the one direction.

5. The locking mechanism according to claim 4, wherein a supporting portion slidably supporting the slider is formed in the attachment plate and a pair of first and second supporting portions is formed with a predetermined gap therebetween in a direction in which the slider slides.

6. The locking mechanism according to claim 5, wherein the first supporting portion is formed near the abutment portion, and the abutment portion is formed at a position adapted to being pressed by the first protrusion on the slider side, and
wherein when the cover is closed, the first protrusion presses the abutment portion, the slider rotates about the second supporting portion, and the abutment portion is pressed down to release the position control portion.

7. The locking mechanism according to claim 6, wherein when the position control portion is released, the slider slides in the one direction to go below the position control portion so as to control upward movement of the slider.

8. The locking mechanism according to claim 7, wherein the lock between the engaging portion and the locking portion is released, and the abutment portion of the slider rotates upward about the second supporting portion, by pressing the slider in the opposite direction so as to lock the cover to the case.

9. The locking mechanism according to claim 1, wherein the locking portion is formed in a “⊃” shape and the engaging portion is formed in a shape capable of engaging with the locking portion by allowing a part of the slider to protrude.

10. The locking mechanism according to claim 1, wherein the cover is elastically urged in a direction in which the cover is opened.

11. The locking mechanism according to claim 3, wherein the end of the first protrusion and the abutment portion have an inclined shape of which the right side is raised.
